(19) United States
(12) Patent Application Publication
(10) Pub. No.: US 2025/0198150 A1
(43) Pub. Date: Jun. 19, 2025

(54) THIN-WALL STRUCTURE WITH TOOTHED SURFACE AND ITS UNFOLDING AND FOLDING MECHANISM

(71) Applicant: Qingdao University of Technology, Qingdao (CN)

(72) Inventors: Ziguo WANG, Qingdao (CN); Yuyan SUN, Qingdao (CN)

(21) Appl. No.: 18/981,381

(22) Filed: Dec. 13, 2024

(30) Foreign Application Priority Data
Dec. 15, 2023 (CN) 202311739590.5

(51) Int. Cl. E04C 3/00; B32B 3/30

(52) U.S. Cl. CPC E04C 3/005; B32B 3/30; B32B 2250/40; B32B 2307/51

(57) ABSTRACT

A thin-wall structure with a toothed surface is provided, wherein the thin-wall structure with the toothed surface is a single-layer thin-wall structure with the toothed surface that can be unfolded and folded, or a multi-layer thin-wall structure with the toothed surface that can be unfolded and folded, the thin-wall structure with the toothed surface has a toothed surface for transmitting interlayer shear forces or meshing transmission. The unfolding and folding mechanism of a thin-wall structure with a toothed surface comprises a roller component, a compression wheel component, and an elastic adjustment mechanism integrated together by a frame, the elastic adjustment mechanism is used to maintain an elastic compression force of the roller component and the compression wheel component. The present disclosure can effectively solve the problems of out-of-plane instability deformation and easy creep deformation during folding, and easy jamming during unfolding of existing thin-wall rollable structures.

### CROSS-REFERENCE TO RELATED APPLICATIONS

This application claims priority to Chinese Application No. 202311739590.5, filed on Dec. 15, 2023, entitled “THIN-WALL STRUCTURE WITH TOOTHED SURFACE AND ITS UNFOLDING AND FOLDING MECHANISM”. These contents are hereby incorporated by reference.

### TECHNICAL FIELD

The present disclosure relates to the technical field of thin-wall supporting structure and its unfolding and folding, in particular to a thin-wall structure with a toothed surface and its unfolding and folding mechanism.

### BACKGROUND

The thin-wall supporting structure of the laminated composite layer, such as the collapsible tubular mast boom, is a thin-wall tubular boom structure made of two “Ω” shaped booms (two-Omega boom) by symmetrical cementation or welding. When the two-Omega boom is wound, it can be rolled and folded into a layer of ribbon and wound on the reel. During unfolding, the section leaving the roller automatically recovers into a double “Ω” type tubular boom.

Currently, the main problem is that in the process of folding and unfolding, the two Omega booms are only connected at the edge of both sides, so the two booms produce interlayer shear force under bending, most of which are neutralized and offset at the junction of the two after transverse transmission, and a small part are offset by the friction of the contact surface. Due to the “shear lag effect” of bending, the normal stress and shear stress of the cross section of the Omega boom are unevenly distributed, and are the largest at the junction, and gradually become smaller away from the junction, which causes the longitudinal displacement of the Omega boom far from the junction to lag behind the longitudinal displacement of the junction, resulting in the incongruous longitudinal deformation of the Omega boom. When the incongruous deformation reaches a certain degree, the excessive in-plane stress makes the local thin wall of the Omega boom unstable and warped out of the plane (wrinkle or unsmooth). Moreover, when the roller radius is smaller, the number of turns of the Omega boom is more and the section width is larger, the warpage accumulated deformation of the Omega boom at the end of unfolding is greater, and the Omega boom is more prone to delamination and looseness. The above problems also exist in other thin-wall supporting structures that can be laminated.

In order to make the two Omega booms as tight as possible, it is necessary to use multiple rolling wheels (guide rollers) to exert a great compression force on the booms, or use the spring to exert a tightening force on the booms. However, these measures will lead to the complexity and burden of the unfolding mechanism, and the reliability of the mechanism will also be reduced. When the boom used for supporting is long, it is necessary to use a larger cross-section diameter or a wider folding width of the boom in order to ensure the stability and bearing capacity of the boom. The “shear lag effect” is more obvious when the transverse shear transmission path of the corresponding member is very long and the interlayer shear force is very large, which makes the cumulative deformation of boom very large. Even if multiple rolling wheels and other measures are adopted, it is difficult to eliminate wrinkles and irregularities. Moreover, excessive rolling force and shear force are likely to result in local plastic deformation or even damage of the Omega booms, making the Omega booms unable to straighten or roll tightly, causing mechanical failures such as jamming, and then leading to failure.

Currently, the unfolding and folding of the thin-wall supporting structures that can be stacked into layers are generally realized by motor driving the roller or compression wheel to rotate, and by the friction traction between the roller or compression wheel and the Omega boom. The friction force is directly proportional to the contact pressure and friction coefficient on the surface of the boom, but the greater the contact pressure, the greater the friction resistance to be withstood in the unfolding of the boom, and the local warpage caused by the above “shear lag effect” will further increase the folding or unfolding resistance. When the friction force is less than these resistances, the Omega boom will be loose when unfolded. When the Omega boom is loose, the cavity will expand to a certain extent, and the motor cannot provide effective traction, resulting in the Omega boom can not be unfolded or rolled, and the mechanism will be stuck and invalid. In addition, due to the excessive interlayer shear force, the width of the interface between thin-wall supporting structures needs to be larger, otherwise it is easy to fall off, and the longer the folding time, the greater the creep deformation of the material, so that it cannot be straightened and smooth. Besides, the fatigue failure occurs in the process of multiple development because the material stress is too large.

### SUMMARY

The purpose of the present disclosure is to provide a thin-wall structure with a toothed surface and its unfolding mechanism that can effectively solve the problems of out-of-plane instability and deformation during folding, and easy creep deformation and easy jamming during unfolding of existing thin-wall rollable structures, in response to the shortcomings of existing technologies.

In order to achieve the above purposes, the present disclosure provides a thin-wall structure with a toothed surface, which is a single-layer thin-wall structure with the toothed surface that can be unfolded and folded, or a multi-layer thin-wall structure with the toothed surface that can be unfolded and folded, the thin-wall structure with the toothed surface has a toothed surface for transmitting interlayer shear forces or meshing transmission.

In one embodiment, the single-layer thin-wall structure with the toothed surface is a C-shaped-cross-section boom;
the multi-layer thin-wall structure with the toothed surface is a toothed two-Omega boom, a toothed two-Omega core plate, a double C-shaped-cross-section boom, a herringbone-cross-section boom, and a Z-shaped-cross-section boom.

In one embodiment, the toothed two-Omega core plate comprises a first elastic thin plate, a second elastic thin plate, and a hollow elastic sandwiched layer arranged between the first elastic thin plate and the second elastic thin plate;
the first elastic thin plate and the second elastic thin plate can be laminated with the hollow elastic sandwiched layer to form a bendable layered structure under compression force.

In one embodiment, the hollow elastic sandwiched layer adopts a semi-sectional toothed two-Omega boom, and at least one side of outer surfaces of the first elastic thin plate and the second elastic thin plate is provided with a toothed section, and its remaining section is a smooth section.

In one embodiment, the hollow elastic sandwiched layer comprises multiple sequentially arranged toothed two-Omega booms, and at least one side of the first elastic thin plate and the second elastic thin plate has toothed two-Omega booms exposed to form a toothed section;
the outer surfaces of the first elastic thin plate and the second elastic thin plate are smooth surfaces.

In second aspect, the embodiments of the present disclosure also provide a unfolding and folding mechanism for a thin-wall structure with a toothed surface, comprising a roller component, a compression wheel component, and an elastic adjustment mechanism integrated together by a frame, the elastic adjustment mechanism is used to maintain an elastic compression force of the roller component and the compression wheel component;
the roller component comprises a roller shaft and a roller rotatably connected to the roller shaft, and the compression wheel component comprises a compression wheel shaft and a compression wheel rotatably connected to the compression wheel shaft; surfaces of the roller and the compression wheel are respectively provided with transmission teeth for meshing with teeth of the thin-wall structure with the toothed surface.

In one embodiment, the elastic adjustment mechanism is connected between the roller shaft and the frame, or between the compression wheel and the frame, or between the roller shaft and the compression wheel.

In one embodiment, the elastic adjustment mechanism is a cantilever elastic support component, and two ends of the roller shaft or compression wheel shaft are connected to the frame through the cantilever elastic support component;
the cantilever elastic support component comprises a cantilever and an elastic hinge component, one end of the cantilever is connected to the roller shaft or the compression wheel shaft, and the other end is hinged to the frame through the elastic hinge component.

In one embodiment, the elastic adjustment mechanism is a scissor-typed elastic support component, and two ends of the roller shaft are respectively connected to the corresponding ends of the compression wheel shaft through the elastic support component;
the scissor-typed elastic support component includes a pair of scissor blades and the elastic hinge component that hinges one end of the pair of scissor blades, the end of the scissor blade that is far away from the elastic hinge component is respectively connected to the roller shaft and the compression wheel shaft.

In one embodiment, the elastic hinge component comprises a hinge shaft, a locking component, and a torsion spring, the hinge shaft is equipped with the torsion spring, which is connected between the cantilever and the frame; the torsion spring stores elastic potential energy for driving the cantilever to drive the roller and the compression wheel to continuously roll and fold the thin-wall structure with the toothed surface.

In one embodiment, the elastic adjustment mechanism is a C-shaped elastic connection frame, and two ends of the roller shaft are respectively connected to the corresponding ends of the compression wheel shaft through the C-shaped elastic connection frame.

In one embodiment, the compression wheel is a single-segment compression wheel or a multi-segment compression wheel, and one or more open cantilever elastic support components or cantilever elastic support components for increasing rolling stiffness are connected between the compression wheel shaft of the multi-segment compression wheel and the frame;
the open cantilever elastic support component comprises an open cantilever, one end of which is hung with the compression wheel shaft, and the other end is connected to the frame through a hinge shaft, and the hinge shaft is equipped with the torsion spring, which is connected between the open cantilever and the frame.

In one embodiment, at least one side of the connection end between the thin-wall structure with the toothed surface and the roller is provided with a widened portion, and the frame is provided with a blocking block for blocking the widened portion.

In one embodiment, it also includes a driving mechanism for driving the compression wheel or roller to rotate;
the frame is equipped with at least one stop switch, and the driving mechanism is electrically connected to the stop switch to stop when the thin-wall structure with the toothed surface is unfolded to a limit position.

In one embodiment, the unfolding and folding mechanism is a single machine or dual machine typed;
when the unfolding and folding mechanism is a single machine typed, the thin-wall structure with the toothed surface is unfolded at an outlet end of the unfolding and folding mechanism;
when the unfolding and folding mechanism is a dual machine typed, the thin-wall structure with the toothed surface is unfolded between the two unfolding and folding mechanisms or wound and stored on the roller inside both.

The thin-wall structure with the toothed surface of the present disclosure can be a single-layer thin-wall structure with a toothed surface or a multi-layer thin-wall structure with a toothed surface. During unfolding and folding, it is stacked into a thin strip or thin plate under the action of compression force. The teeth on the inner surface of each layer mesh with each other. When the layered structure is curled or folded, the interlayer shear displacement is cancelled by the teeth meshing effect, reducing the interlayer shear displacement and avoiding the occurrence of shear lag between layers when the layered structure such as the two-Omega boom is curled, which leads to the out-of-plane instability of the thin strip member, cumulative deformation, folding inability, and the phenomenon of the boom being unable to be tightly rolled, thereby reducing the mechanical failure rate of the unfolding and folding mechanism.

The unfolding and folding mechanism of the present disclosure, due to the meshing effect of the teeth on each layer of the multi-layer thin-wall structure with the toothed surface, will not experience cumulative interlayer deformation or out-of-plane instability during folding and storage. Therefore, only the force that can flatten the multi-layer thin-wall with the toothed surface needs to be provided between the roller and the compression wheel. Due to the meshing effect between the teeth on the roller and the compression wheel and the surface teeth of the thin-wall structure with the toothed surface, the multi-layer thin-wall structure with the toothed surface and the single-layer thin-wall structure with the toothed surface (C-shaped-cross-section boom), will automatically wound on the roller under driving action, and there will be no delamination or loosening phenomenon. Furthermore, the roller and the compression wheel apply a compression force to the thin-wall structure with the toothed surface through an elastic adjustment mechanism, which can ensure the meshing effect during the unfolding and folding process.

### BRIEF DESCRIPTION OF THE DRAWINGS

FIG. 1a is an exploded view of the toothed two-Omega boom in Embodiment 1 of the present disclosure;

FIG. 1b is a perspective view of the toothed two-Omega boom in Embodiment 1 of the present disclosure;

FIG. 2a is a schematic diagram of the component of the unfolding and folding mechanism in the Embodiment 2 of the present disclosure;

FIG. 2b is an exploded view of the unfolding and folding mechanism in Embodiment 2 of the present disclosure;

FIG. 2c is a schematic diagram of the folding of the unfolding and folding mechanism in the Embodiment 2 of the present disclosure;

FIG. 2d is a schematic side view of the folding of the unfolding and folding mechanism in the Embodiment 2 of the present disclosure;

FIG. 2e is a schematic diagram of the unfolded of the unfolding and folding mechanism in the Embodiment 2 of the present disclosure;

FIG. 2f is the appearance of the unfolding and folding mechanism in the Embodiment 2 of the present disclosure;

FIG. 3a is a schematic diagram of the partial structure of the unfolding and folding mechanism in Embodiment 3 of the present disclosure;

FIG. 3b is a schematic diagram of the component of the unfolding and folding mechanism in Embodiment 3 of the present disclosure;

FIG. 4a is an exploded view of the partial structure of the driving mechanism in Embodiment 4 of the present disclosure;

FIG. 4b is an installation diagram of the unfolding of the driving mechanism in Embodiment 4 of the present disclosure;

FIG. 4c is an installation diagram of the folding of the driving mechanism in the Embodiment 4 of the present disclosure;

FIG. 5a is an exploded view of the elastic adjustment mechanism in Embodiment 5 of the present disclosure;

FIG. 5b is an installation diagram of the elastic adjustment mechanism in Embodiment 5 of the present disclosure;

FIG. 6a is an exploded view of the elastic adjustment mechanism in Embodiment 6 of the present disclosure;

FIG. 6b is an installation diagram of the elastic adjustment mechanism in Embodiment 6 of the present disclosure;

FIG. 6c is an installation diagram of the unfolding and folding mechanism in Embodiment 6 of the present disclosure;

FIG. 7a is an exploded view of the elastic adjustment mechanism in Embodiment 7 of the present disclosure;

FIG. 7b is an installation diagram of the elastic adjustment mechanism in Embodiment 7 of the present disclosure;

FIG. 8a is a three-dimensional schematic diagram of a C-shaped-cross-section boom in its natural state in Embodiment 8 of the present disclosure;

FIG. 8b is a three-dimensional schematic diagram of the humanoid-cross-section boom in its natural state in Embodiment 8 of the present disclosure;

FIG. 9a is a schematic diagram of the cooperation between the roller component and the compression wheel component in the Embodiment 9 of the present disclosure;

FIG. 9b is a schematic diagram of the unit structure of the toothed surface area of the two-Omega core plate in Embodiment 9 of the present disclosure;

FIG. 9c is a schematic diagram of the unit structure of the smooth surface area of the two-Omega core plate in Embodiment 9 of the present disclosure;

FIG. 9d is a schematic diagram of the pressed state of the smooth surface unit of the two-Omega core plate in Embodiment 9 of the present disclosure;

FIG. 10a is an exploded view of the unfolding and folding mechanism in Embodiment 10 of the present disclosure;

FIG. 10b is a schematic diagram of unfolding the two-Omega core plate by the unfolding and folding mechanism in Embodiment 10 of the present disclosure;

FIG. 10c is a schematic diagram of folding the two-Omega core plate by the unfolding and folding mechanism in Embodiment 10 of the present disclosure;

FIG. 10d is a side view of folding the two-Omega core plate by the unfolding and folding mechanism in Embodiment 10 of the present disclosure;

FIG. 10e is a schematic diagram of the two-Omega core plate completely folded in the unfolding and folding mechanism of Embodiment 10 of the present disclosure;

FIG. 10f is a schematic diagram of the unfolding of the two-Omega core plate in Embodiment 10 of the present disclosure;

FIG. 10g is a schematic diagram of the installation of the second elastic frame component in Embodiment 10 of the present disclosure;

FIG. 11a is a structure schematic diagram of the folding of the two-Omega core plate in Embodiment 11 of the present disclosure;

FIG. 11b is a schematic diagram of the folding of the two-Omega core plate in Embodiment 11 of the present disclosure;

FIG. 12a is a schematic diagram of the unfolding of the two-Omega core plate in Embodiment 12 of the present disclosure;

FIG. 12b is an exploded view of the driving mechanism in Embodiment 12 of the present disclosure;

FIG. 12c is a schematic diagram of the component of the driving mechanism in the frame in Embodiment 12 of the present disclosure;

FIG. 13 is a side view of folding two-Omega core plate by the unfolding and folding mechanism in Embodiment 13 of the present disclosure; and

FIG. 14 is a schematic diagram of folding two-Omega core plate by the unfolding and folding mechanism in Embodiment 14 of the present disclosure.

1—Shell; 101—Left shell; 102—Right shell; 103—Top shell; 104—Upper limit plate; 105—Lower limit plate; 2—Frame; 201—First shaft hole group; 202—Second shaft hole group; 203—Third shaft hole group; 204—Motor seat; 205—Support lug; 3—Thin-wall structure with toothed surface; 30—toothed two-Omega boom; 301—Omega boom; 302—two-Omega boom connection end; 303—Plug; 304—widened portion; 31—Toothed two-Omega core plate; 310—Toothed two-Omega core plate connection end; 311—First elastic thin plate; 312—Second elastic thin plate; 313—semi-sectional toothed two-Omega boom; 32—C-shaped-cross-section boom; 33—Herringbone-cross-section boom; 4—Roller component; 401—Roller shaft; 402—Bearings; 403—Roller connection end; 404—Roller; 4041—Roller toothed section; 4042—Roller smooth section; 5—Compression wheel component; 501—Compression wheel shaft; 502—Compression wheel; 5021—Compression wheel toothed section; 5022—Compression wheel smooth section; 6—Elastic adjustment mechanism; 60—Cantilever elastic support component; 601—Hinge shaft; 602—Torsion spring; 603—Locking component; 604—Cantilever; 605—Open cantilever; 61—Open cantilever elastic support component; 7—Driving mechanism; 701—Driving gear; 702—Driving motor; 8—Blocking block; 9—First stop switch; 10—Second stop switch; 11—C-shaped elastic connection frame; 12—Scissor-typed elastic support component; 1201—Scissor blade; 13—Screw; 14—Screw hole.

### DETAILED DESCRIPTION OF THE EMBODIMENT

In order to make the technical problems, technical solutions and beneficial effects of the present invention clearer, the present invention will be further described in detail below with reference to the accompanying drawings and embodiments.

In the present invention, the terms “first,” “second,” “third” and the like are merely for the purpose of description, but cannot be understood as indicating or implying relative importance. The term “multiple” means two or more unless otherwise explicitly defined. The terms “mount,” “connect with,” “connect,” “fix,” and the like shall be understood in a broad sense. For example, “connect” may mean being fixedly connected, detachably connected, or integrally connected; and “connect with” may mean being directly connected or indirectly connected through an intermediary. For those of ordinary skill in the art, specific meanings of the above terms in the present invention can be understood according to specific situations.

In the description of the present invention, it should be understood that if orientation or position relations indicated by the terms such as “upper,” “lower,” “left,” “right,” “front,” “back,” and the like are based on the orientation or position relations shown in the drawings, and the terms are intended only to facilitate the description of the present invention and simplify the description, rather than indicating or implying that the apparatus or element referred to must have a particular orientation and be constructed and operated in the particular orientation, and therefore cannot be construed as a limitation on the present invention.

### Embodiment 1

This embodiment provides a thin-wall structure with a toothed surface, as shown in FIGS. 1a and 1b. The thin-wall structure with the toothed surface is a toothed two-Omega boom 30, which is a double-layer thin-wall structure with a toothed surface.

Specifically, the toothed two-Omega boom 30 is formed by two pieces of booms 301 in an “Ω” shaped thin shell, which are folded together. The joint surfaces of the two side edge can be connected by adhesive or welding. The inner and outer surfaces of Omega boom 301 are both processed with teeth, with the inner surface teeth used to transmit interlayer shear forces and the outer surface teeth used for transmission and clamping. Under the action of compression force, the two Omega booms 301 are folded along the folding surface, and the teeth on their inner surfaces are engaged with each other.

In order to reduce the weight of the structure and the bending stiffness after stacking, mesh holes are regularly opened on the thin-wall structure with the toothed surface.

### Embodiment 2

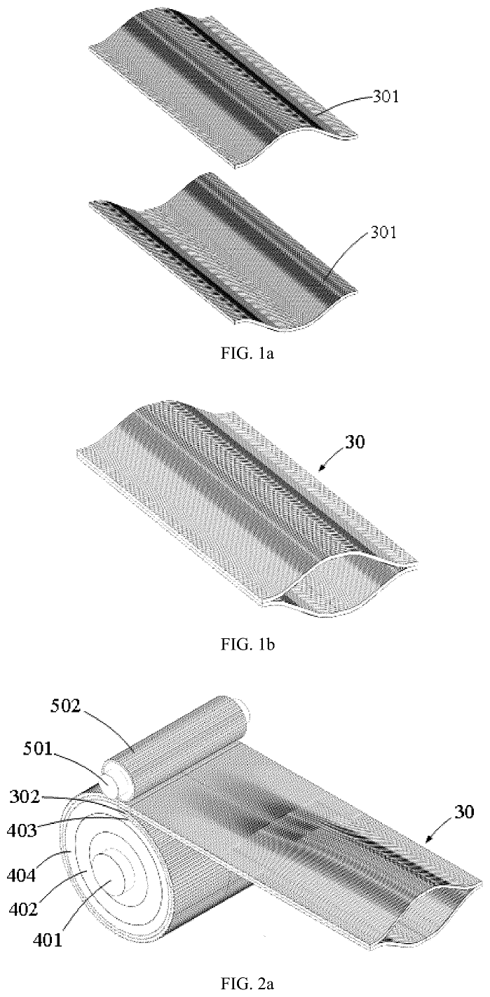

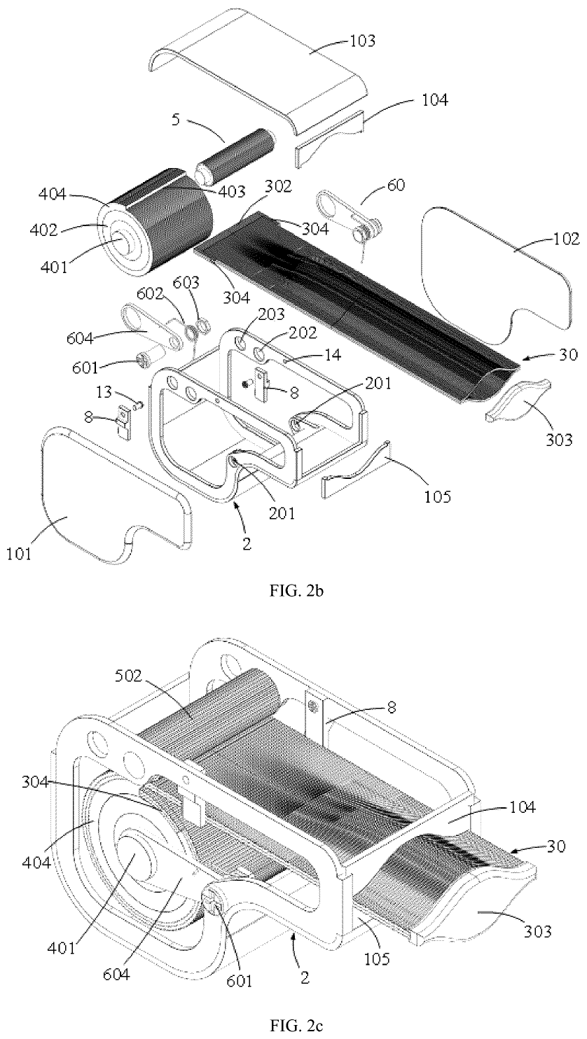

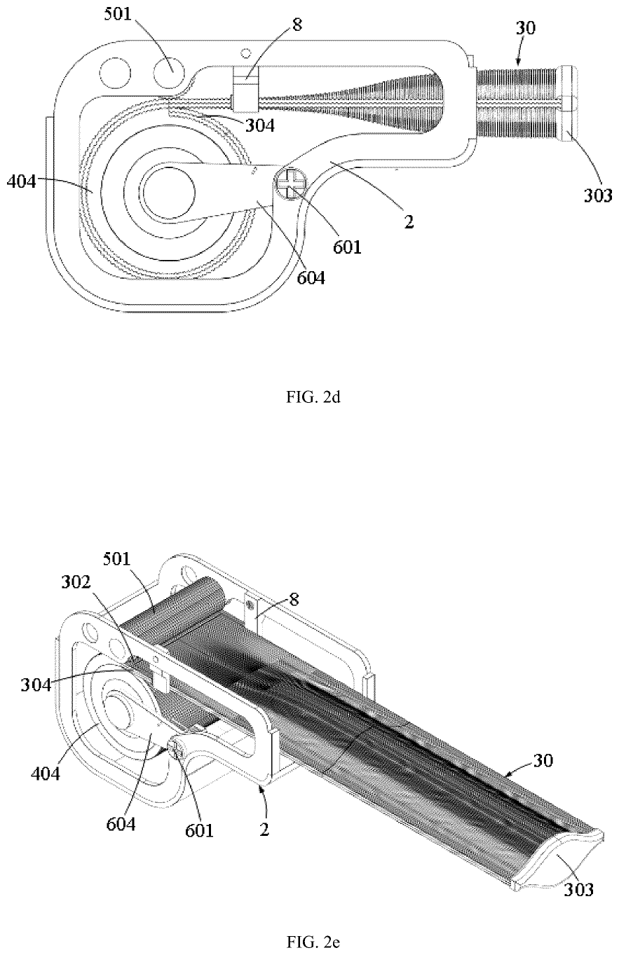

This embodiment provides a unfolding and folding mechanism for a thin-wall structure with a toothed surface, which is particularly suitable for the thin-wall structure with the toothed surface described in Embodiment 1, as shown in FIGS. 2a-2f. The unfolding and folding mechanism includes a roller component 4, a compression wheel component 5, and an elastic adjustment mechanism 6 integrated and installed on the frame 2. The roller component 4 is used to fold the toothed two-Omega boom 30, the compression wheel component 5 is used as a compression wheel, and the elastic adjustment mechanism 6 is used to maintain the elastic compression force of the roller component 4 and the compression wheel component 5. The toothed two-Omega boom 30 is compressed by the compression wheel component 5 and the roller component 4 to mesh the layers and wound onto the roller component 4.

As shown in FIG. 2b, the roller component 4 includes a roller shaft 401 and a roller 404 rotatably connected to the roller shaft 401. The compression wheel component 5 includes a compression wheel shaft 501 and a compression wheel 502 rotatably connected to the compression wheel shaft 501. The axis of the compression wheel 502 is parallel to the axis of the roller 404. In this embodiment, the roller 404 is rotatably connected to the roller shaft 401 through a bearing 402. Similarly, a bearing is also installed between the compression wheel 502 and the compression wheel shaft 501.

The surfaces of the roller 404 and the compression wheel 502 are both processed with teeth that match and mesh with the teeth on the surface of the toothed two-Omega boom 30. The tail end of the toothed two-Omega boom 30 is equipped with a compressed and folded two-Omega boom connection end 302, which is used to connect with the roller 404. The tail end of the toothed two-Omega boom 30 passes through between the compression wheel 502 and the roller 404 and is fixed and folded around the roller 404. The outlet direction gradually expands elastically from the compressed and folded state to a natural tubular shape of a certain height, extending to the head end of the toothed two-Omega boom 30 and sealed with a plug 303.

The outer circumference baseline of the cross section of the roller 404 is the Archimedean spiral unfolding line (equidistant spiral line) that rotates one circle, and a roller connection end 403 is set at the starting end area of the spiral unfolding line on its outer circumference for installing the two-Omega boom connection end 302. The distance (pitch) between the starting and ending points of the spiral unfolding line is the same as the thickness of the two-Omega boom connection end 302 or the folding thickness of the toothed two-Omega boom 30. The lower surface teeth of the two-Omega boom connection end 302 mesh with the teeth of the roller connection end 403, and are connected by bonding or mechanical anchoring. At the interface position between the two, the upper surface of the two-Omega boom connection end 302 smoothly intersects with the outer circumference of the roller 404.

In this embodiment, the elastic adjustment mechanism 6 is a cantilevered elastic support component 60. Two ends of the roller shaft 401 are connected to the frame 2 through the cantilevered elastic support component 60, and the two ends of the compression wheel shaft 501 are assembled with the second shaft hole group 202 opened on the frame 2.

As shown in FIGS. 2b to 2e, the cantilever elastic support component 60 includes a cantilever 604 and an elastic hinge component. One end of the cantilever 604 is connected to the roller shaft 401, and the other end is hinged to the frame 2 through the elastic hinge component. The elastic hinge component includes a hinge shaft 601, a locking component 603, and a torsion spring 602 assembled together. One end of the hinge shaft 601 passes through the first shaft hole group 201 opened in the frame 2, and the shaft segment of the hinge shaft 601 located inside the frame 2 is fitted with a torsion spring 602. One end of the torsion spring 602 is connected to the cantilever 604, and the other end is connected to the frame 2. The torsion spring 602 is limited to the hinge shaft 601 by the locking component 603. During working, the cantilever 604 drives the hinge shaft 601 to rotate, and the rotation of the hinge shaft 601 causes the torsion spring 602 to undergo elastic deformation. The torsion spring 602 always acts on the cantilever 604, forcing the roller 404 to always approach the compression wheel 502, forcing the folded toothed two-Omega boom 30 to tightly wrap around the roller 404.

In this embodiment, the teeth on the surface of the toothed two-Omega boom 30 is a full teeth structure. Correspondingly, the surface teeth of the roller 404 and the compression wheel 502 correspond to the teeth on the surface of the toothed two-Omega boom 30, that is, the surfaces of the roller 404 and the compression wheel 502 are also covered with teeth that mesh with them for transmission.

The cross section of the teeth can be trapezoidal, arc-shaped, or other shapes. Boom 301 is made of high elastic metal materials such as beryllium copper, nickel titanium memory alloy, high-strength steel, etc. It can also be made of composite materials such as high-strength fiber-reinforced resin, such as carbon fiber, glass fiber, basalt fiber, steel fiber, rubber, polyimide and other matrix composite materials, etc. The thickness of boom 301 can be taken within the range of 0.01-2 mm.

The exterior of the frame 2 is equipped with the shell 1 to protect the components installed on the frame 2. In this embodiment, the cross section of the frame 2 is in an L-shaped structure, where the cross section refers to the vertical cross section along the length direction of the toothed two-Omega boom 30. The shell 1 includes a left shell 101, a right shell 102, and a top shell 103 that are closed together. A unfolding and folding channel is formed between the top shell 103 and the top of the frame 2 for the toothed two-Omega boom 30 to unfold and fold. The front end of the unfolding and folding channel is equipped with an upper limit plate 104 and a lower limit plate 105. The upper limit plate 104 and the lower limit plate 105 can be assembled with the shell 1 or the frame 2. The upper limit plate 104 and the lower limit plate 105 enclose the cross-sectional shape of the toothed two-Omega boom 30, which can move up and down appropriately at the front end of the unfolding and folding channel together with the toothed two-Omega boom 30.

In order to avoid excessive unfolding of the toothed two-Omega boom 30, the widened two-Omega boom portions 304 are installed on both sides of the two-Omega boom connection end 302, and correspondingly, blocking blocks 8 are symmetrically installed on both sides of the frame 2. When the toothed two-Omega boom 30 is completely unfolded, the widened portion 304 leaves the outer circumferential surface of the roller 404, and the motion state changes from rotation to outward translation. When the widened portion 304 touches the blocking block 8, it reaches the maximum unfolding position. The blocking block 8 can be disassembled and assembled through a screw 13 and a screw hole 14 provided on the frame 2.

When the toothed two-Omega boom 30 needs to be folded, the toothed two-Omega boom 30 drives the roller 404 to perform unfolding operation under the inward thrust. Under the dual action of rolling and meshing between the roller 404 and the compression wheel 502, the toothed two-Omega boom 30 enters the transition zone, rolling and folding zone, and unfolding zone in sequence from the expanded natural tubular shape. The teeth on both inner surfaces of the two-Omega boom 30 in the rolling and folding zone and unfolding zone are meshed. The teeth on the upper and lower surfaces of the two-Omega boom 30 in the rolling and folding zone are respectively rolled and meshed with the compression wheel 502 and the roller 404. The innermost two-Omega boom segment in the unfolding zone is meshed with the outer circumferential teeth of the roller 404. When continuing to wind, the lower surface teeth of the two-Omega boom segment to be wound are meshed with the upper surface teeth of the wound two-Omega boom segment.

During unfolding of the toothed two-Omega boom 30, as the number of unfolding turns increases, the unfolding diameter also increases accordingly. Due to the installation method of the roller component 4 using elastic swing support, in order to adapt to the increasing unfolding diameter, the roller component 4 will adapt to the lower swing and expand the unfolding space. During the lower swing process, the torsion spring 602 will synchronously deform and continuously provide elastic force to the roller component 4, so that the roller component 4 maintains a tendency to approach the compression wheel 502, thereby ensuring that the roller 404 and the compression wheel 502 continue to roll the toothed two-Omega boom 30.

When the toothed two-Omega boom 30 needs to be unfolded, the toothed two-Omega boom 30, under the action of outward tension, drives the roller 404 to rotate and drives the toothed two-Omega boom 30 in the unfolding zone to perform the unfolding operation. The unfolding operation is the reverse movement of the unfolding operation, that is, as the toothed two-Omega boom 30 in the unfolding zone is rolled and unfolded, the number of turns wound on the roller 404 decreases, and the total outer diameter of the unfolding also decreases accordingly. The roller component 4 can adaptively swing upwards. At the same time, under the twisting force of the torsion spring 602, the roller 404 and the compression wheel 502 always maintain a compression trend, so that the toothed two-Omega boom 30 in the unfolding zone is always meshed around the roller 404, which helps the boom to smoothly unfold and avoid the occurrence of tension.

In this embodiment, due to the meshing effect between the toothed two-Omega boom 30 and the roller 404, as long as the roller 404 and the compression wheel 502 provide sufficient compression force to the toothed two-Omega boom 30, there will be no looseness during the unfolding process. Due to the teeth of the two-Omega boom 30, it can be tightened without the need for a spring, reducing the number of compression wheels in the clamping mechanism. The folding and unfolding operations can be performed by manually pushing and pulling, simplifying the unfolding mechanism and increasing the unfolding reliability.

Due to the meshing state of the two inner surfaces of the folding zone and the unfolding zone of the toothed two-Omega boom 30, the interlayer shear displacement of the toothed two-Omega boom 30 is offset by the toothed meshing effect when curled or folded, reducing the interlayer shear displacement. This meshing effect avoids the occurrence of interlayer shear lag, out-of-plane instability, and occurrence of tension in the unfolding zone, and avoids mechanical failures such as loosening and jamming during the operation of two-Omega boom folding and unfolding. Due to the storage of elastic potential energy in the unfolding process, the mechanism can unfold on its own without the need for power when the beam boom is exposed, even with low friction.

### Embodiment 3

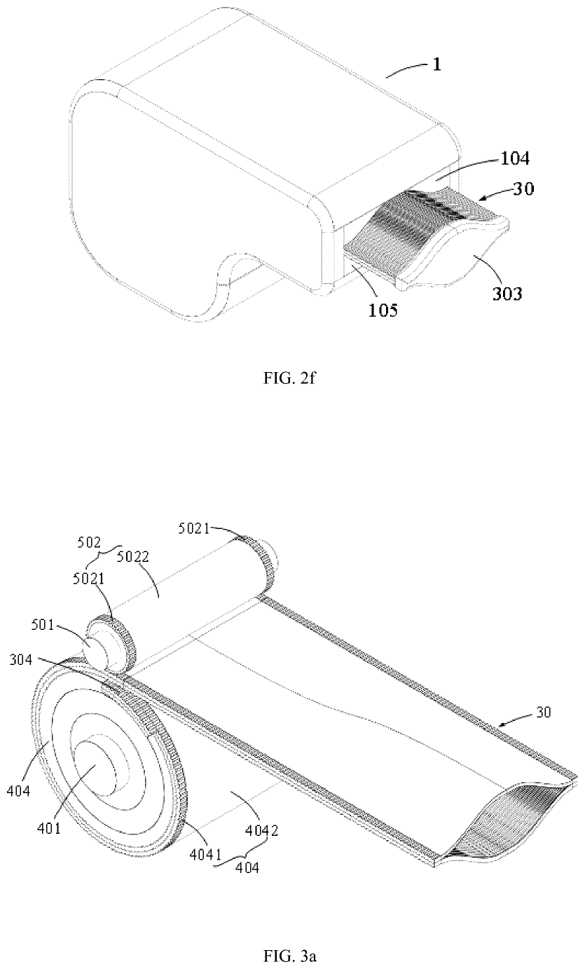

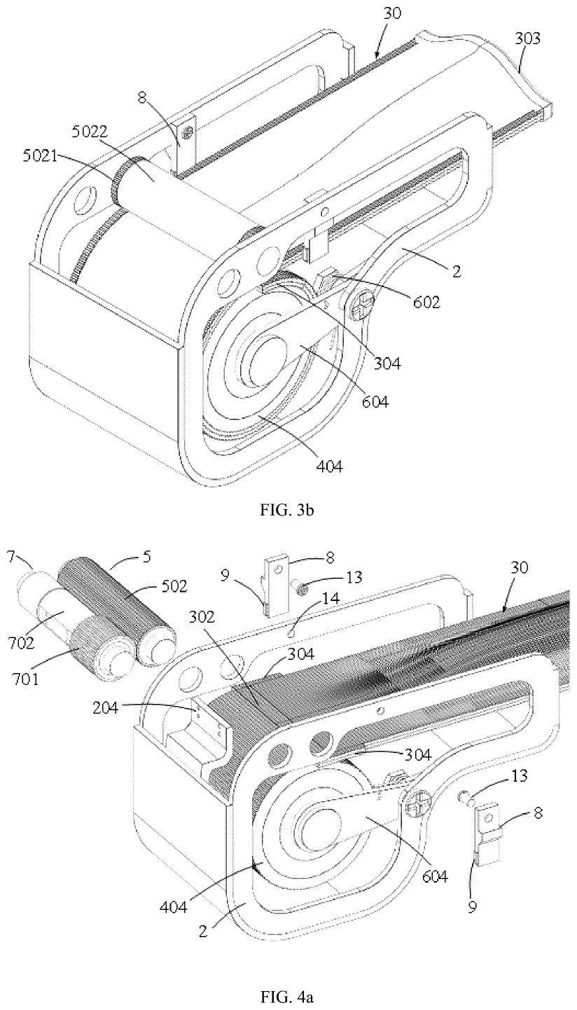

This embodiment provides a unfolding and folding mechanism of a thin-wall structure with a toothed surface, which differs from Embodiment 2 in that it is applicable to a toothed two-Omega boom 30 with teeth structures only set on both sides of the outer surface, and the outer surface of the middle area is smooth. Correspondingly, as shown in FIGS. 3a and 3b, the roller 404 and the compression wheel 502 of the unfolding and folding mechanism are only provided with corresponding teeth on both sides for meshing and transmission. The middle of the roller 404 and the compression wheel 502 are both smooth surfaces, that is, the surface of the roller 404 is divided into a roller toothed section 4041 and a roller smooth section 4042, and the surface of the compression wheel 502 is divided into a compression wheel toothed section 5021 and a compression wheel smooth section 5022.

Other structures are the same as Embodiment 2, and will not be repeated here.

### Embodiment 4

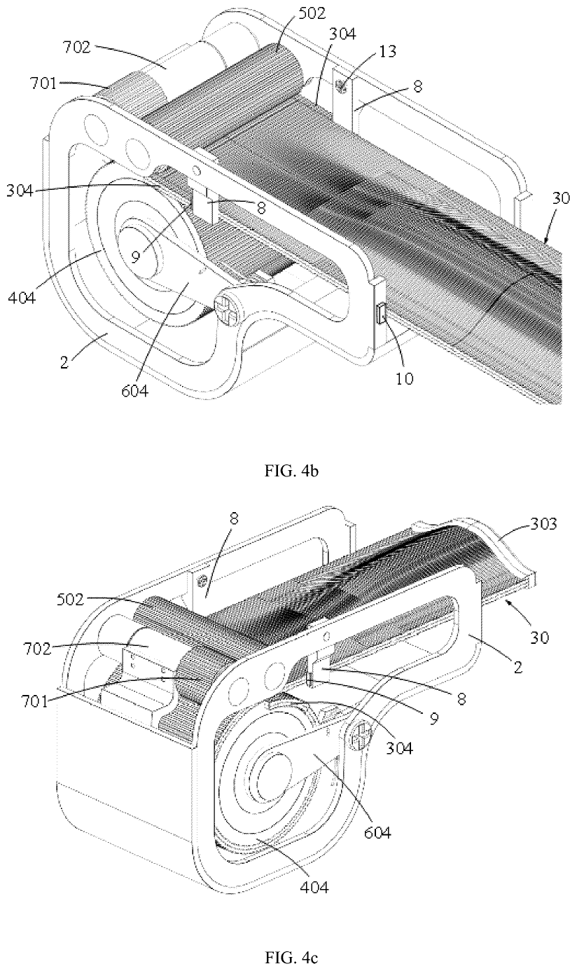

This embodiment provides a unfolding and folding mechanism of a thin-wall structure with a toothed surface, which differs from Embodiment 2 in that a driving mechanism 7 is provided, as shown in FIGS. 4a-4c. The driving mechanism 7 is installed at the rear of the compression wheel component 5, and includes a driving motor 702 and a driving gear 701 installed at the output end of the driving motor 702. The driving motor 702 is installed on the frame 2 through a motor seat 204, and the driving gear 701 meshes with the teeth on the surface of the compression wheel 502 for transmission.

During operation, the compression wheel 502 is directly used as the transmission wheel to drive the roller 404 to rotate, achieving the folding and unfolding of the toothed two-Omega boom 30. In specific applications, a battery compartment can be formed behind the motor seat 204. In addition, the motor shaft is installed in the third shaft hole group 203 reserved in frame 2 to ensure the transmission stiffness.

In order to accurately locate the extreme unfolding and folding position of the toothed two-Omega boom 30, this embodiment also includes a touch type stop switch, as shown in FIGS. 4a and 4b. The blocking block 8 is equipped with a first stop switch 9, and the front end of the frame 2 is equipped with a second stop switch 10. Both the first stop switch 9 and the second stop switch 10 are electrically connected to the driving motor 702. When the widened portion 304 touches the blocking block 8, the first stop switch 9 is triggered, causing the driving motor 702 to stop operating. When the plug 303 of the toothed two-Omega boom 30 touches the frame 2, the second stop switch 10 is triggered, which can also stop the action of the driving motor 702.

It can be understood that in other embodiments, the driving gear 701 may not be provided, and the roller component 4 can be directly driven by the driving motor 702.

Other structures are the same as Embodiment 2, and will not be repeated here.

### Embodiment 5

This embodiment provides a unfolding and folding mechanism of a thin-wall structure with a toothed surface, which differs from Embodiment 2 in that the installation position of the cantilever elastic support component 60 is different.

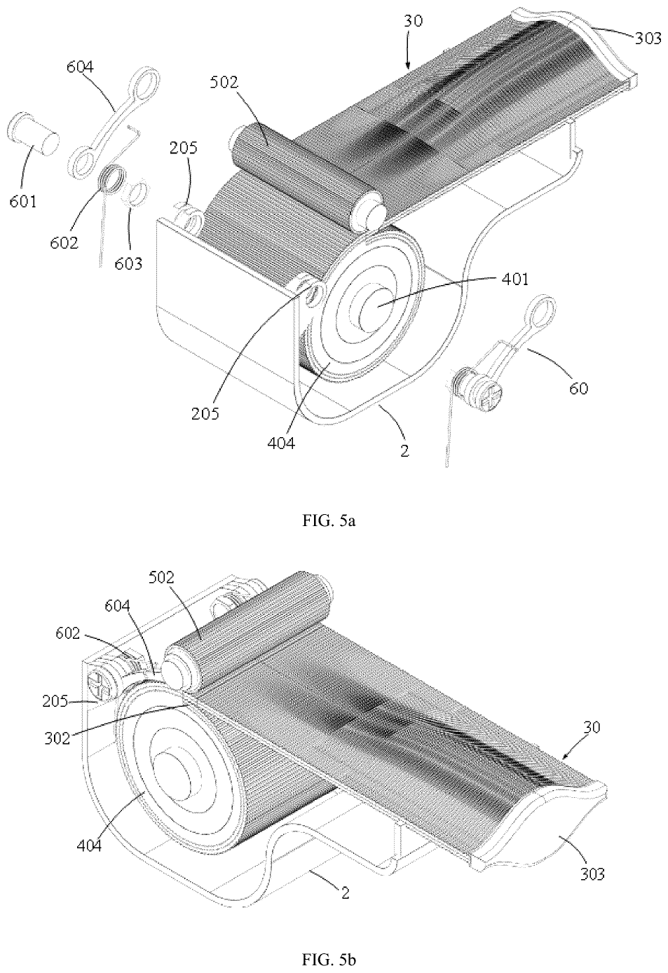

As shown in FIGS. 5a and 5b, the two ends of the compression wheel shaft 501 are connected to the frame 2 through cantilever elastic support components 60, and two ends of the roller shaft 401 are matched with the shaft holes on the frame 2. At the same time, in order to accommodate the installation of the cantilever elastic support component 60, a support lug 205 is integrated at the rear of the frame 2.

Other structures are the same as Embodiment 2, and will not be repeated here.

### Embodiment 6

This embodiment provides a unfolding and folding mechanism of a thin-wall structure with a toothed surface, which differs from Embodiment 2 in that the structure and installation position of the elastic adjustment mechanism 6 are different.

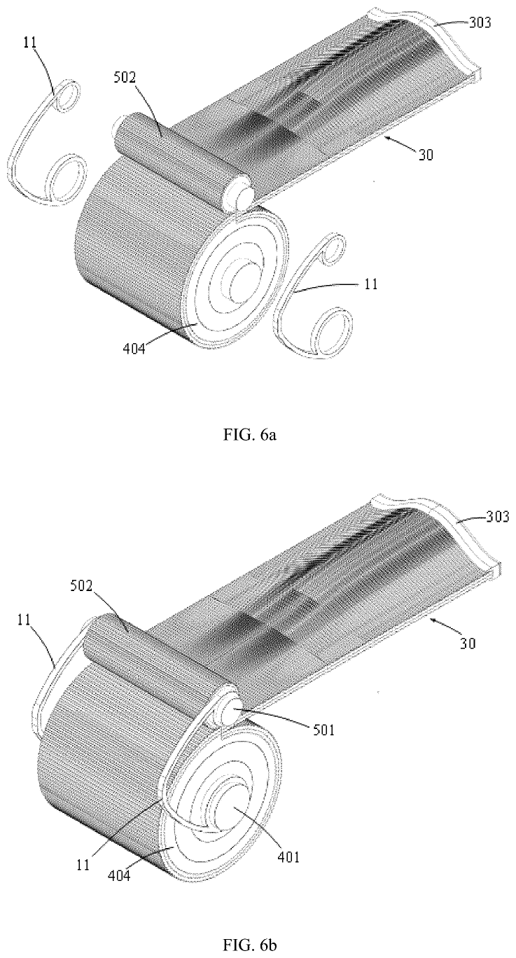

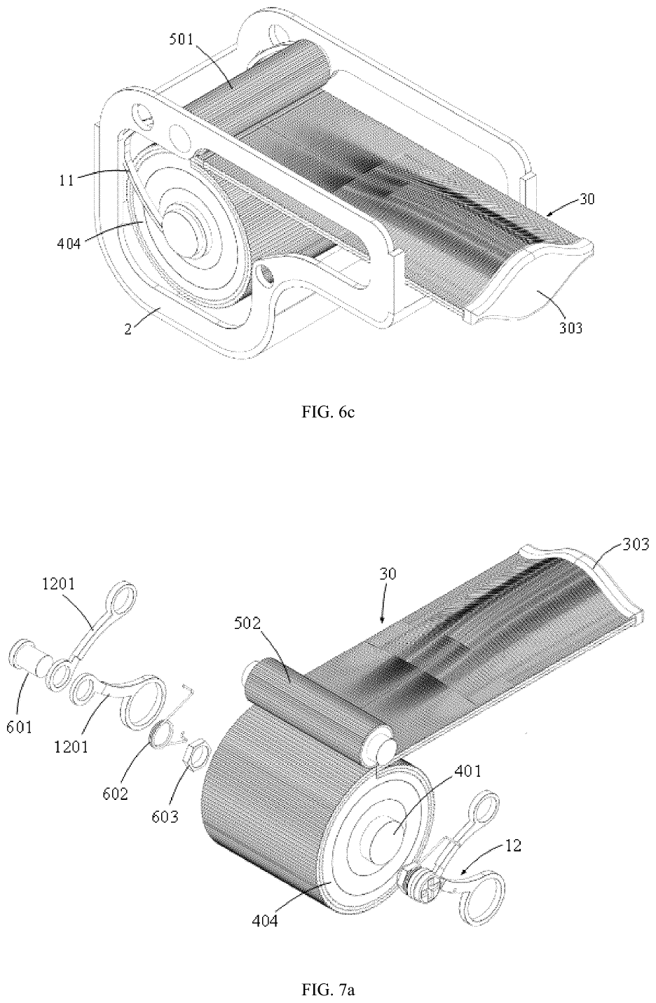

As shown in FIGS. 6a-6c, the elastic adjustment mechanism 6 is a C-shaped elastic connection frame 11, and two ends of the roller shaft 401 are respectively connected to the corresponding ends of the compression wheel shaft 501 through the C-shaped elastic connection frame 11. The roller shaft 401 or the compression wheel shaft 501 is assembled with the frame 2. The main body of the C-shaped elastic connection frame 11 is in a C-shaped structure, and the two ends of the main body respectively form snap rings, which are fixed to the roller shaft 401 and the compression wheel shaft 501 through corresponding snap rings.

During operation, the meshing and compression force of the toothed two-Omega boom 30 comes from the elastic recovery force of the C-shaped elastic connection frame 11. During the unfolding operation of the roller 404, as the number of unfolding turns increases, the C-shaped elastic connection frame 11 opens elastically to meet the demand for expanding the unfolding space. When the roller 404 is used for unfolding, the C-shaped elastic connection frame 11 is elastically folded.

Other structures are the same as Embodiment 2, and will not be repeated here.

### Embodiment 7

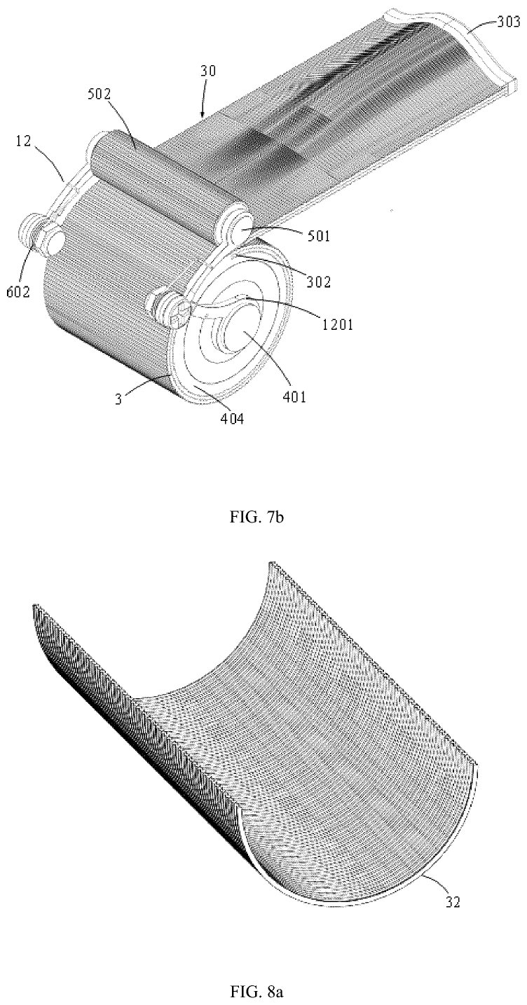

This embodiment provides a unfolding and folding mechanism of a thin-wall structure with a toothed surface, which differs from Embodiment 2 in that the elastic adjustment mechanism 6 is a scissor-typed elastic support component 12, as shown in FIG. 7a and FIG. 7b. Two ends of the roller shaft 401 are respectively connected to the corresponding ends of the compression wheel shaft 501 through the scissor-typed elastic support component 12.

The scissor-typed elastic support component 12 includes a pair of scissor pieces 1201, which are hinged by an elastic hinge component. One end of the scissor piece 1201 away from the elastic hinge component is respectively assembled with the shaft end of the roller shaft 401 and the compression wheel shaft 501. Either the compression wheel shaft 501 or the roller shaft 401 is directly installed on the frame 2. During operation, elastic compression force is provided by the scissor-typed elastic support component 12.

Other structures are the same as Embodiment 2, and will not be repeated here.

It should be noted that the provision of elastic compression force is not limited to the above method. It can also be achieved by setting a groove on the frame 2, and the shaft of the compression wheel 502 or the roller 404 slides along the groove under the action of the spring, applying compression force to the toothed two-Omega boom 30 between the two, to achieve the folding and unfolding of the toothed two-Omega boom 30.

### Embodiment 8

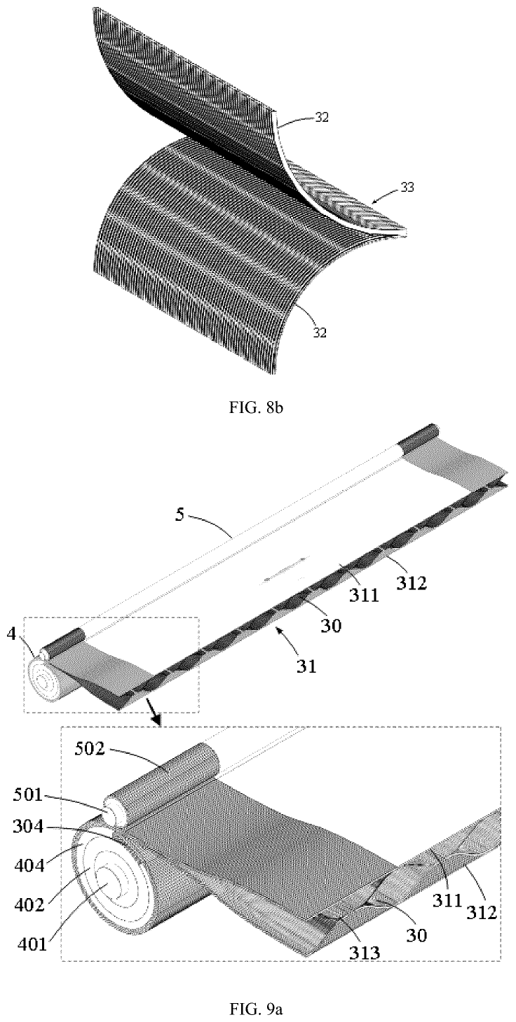

This embodiment provides a thin-wall structure with a toothed surface, which differs from Embodiment 1 in that the thin-wall structure with the toothed surface adopts an open cross section, specifically a C-shaped-cross-section boom 32 as shown in FIG. 8a or a herringbone-cross-section boom 33 as shown in FIG. 8b. The herringbone-cross-section boom 33 is composed of two elastic thin plates stacked together to form a herringbone structure.

The surface of each type of boom is provided with a teeth structure, and Other structures are the same as in Embodiment 1, which will not be repeated here.

In addition, the provision of thin-wall structures with toothed surfaces is not limited to the above methods, and can also be in the form of double C-shaped-cross-section booms, Z-shaped-cross-section booms, and other forms.

### Embodiment 9

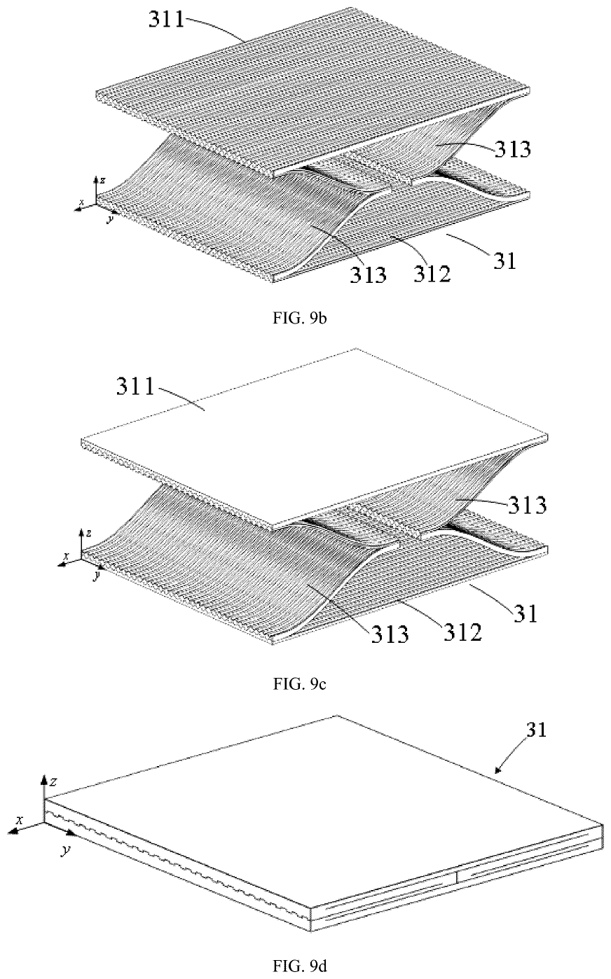

This embodiment provides a thin-wall structure with a toothed surface, as shown in FIGS. 9b-9d. The thin-wall structure with the toothed surface is a folded and unfolded toothed two-Omega core plate 31, which includes a first elastic thin plate 311, a second elastic thin plate 312, and a hollow elastic sandwiched layer. The elastic sandwiched layer is arranged between the first elastic thin plate 311 and the second elastic thin plate 312. Under the action of compression force, the upper and lower layers of elastic thin plates, together with the elastic sandwiched layer, are stacked to form a bendable layered structure. After the pressure is removed, the structure returns to its original natural state, that is, a hollow thin-wall support structure.

The elastic sandwiched layer is composed of at least one of the semi-sectional toothed two-Omega boom 313 and the toothed two-Omega boom 30.

As shown in FIG. 9a, semi-sectional toothed two-Omega booms 313 with outward facing openings and parallel arrangement are clamped on both sides between the first elastic thin plate 311 and the second elastic thin plate 312. The sectional surface of the semi-sectional toothed two-Omega boom 313 is connected to the two sides of the two elastic thin plates facing each other.; The middle area of the two elastic thin plates is clamped with multiple parallel arranged toothed two-Omega booms 30.

The inner surfaces of the first elastic thin plate 311 and the second elastic thin plate 312 are processed with a teeth structure that matches and meshes with the surface teeth of the semi-sectional toothed two-Omega boom 313 and the toothed two-Omega boom 30. The outer surfaces are processed with teeth structures on both sides, forming a toothed section. There is no teeth in the middle, which is a smooth section equipped with a flexible layer.

FIGS. 9b-9d shows the structure cells of the toothed surface area and the smooth surface area of the toothed two-Omega core plate 31. in a natural state, the elastic thin plate is fixedly connected to the toothed two-Omega boom 30 and the semi-sectional toothed two-Omega boom 313 only in the upper and lower top contact surface areas by bonding or welding. Other non-connecting surface areas can be opened by unloading force and engaged by force.

In order to prevent the inability to fold the booms due to lateral deformation during unfolding and folding, the center axis spacing between adjacent toothed two-Omega boom 30, as well as the center axis spacing between the semi-sectional toothed two-Omega boom 313 and adjacent toothed two-Omega boom 30, shall not be less than the folding width of the boom.

### Embodiment 10

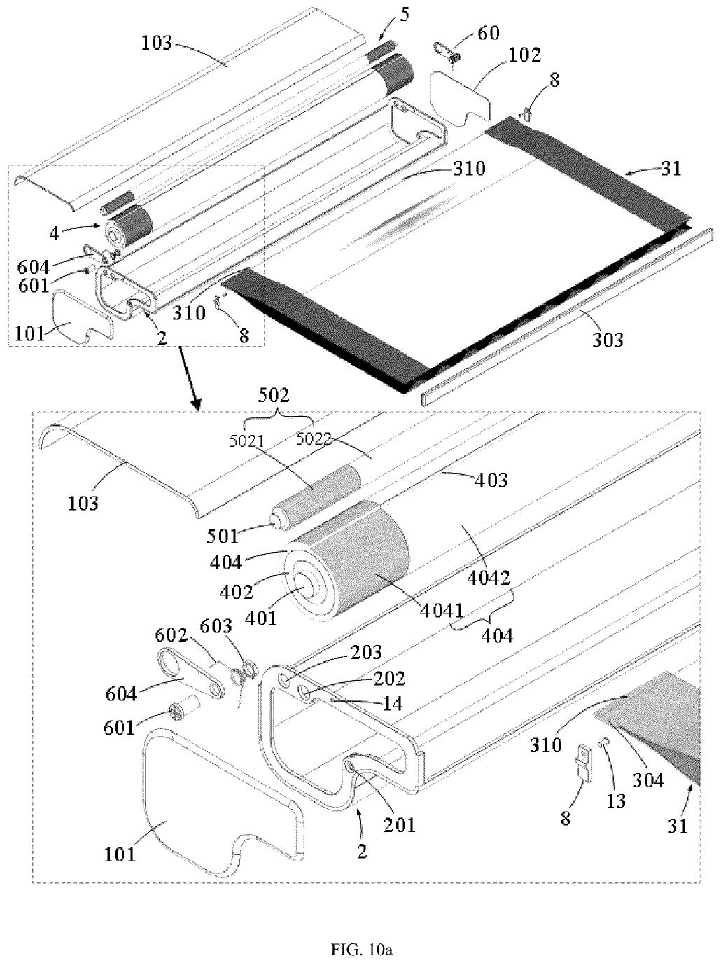

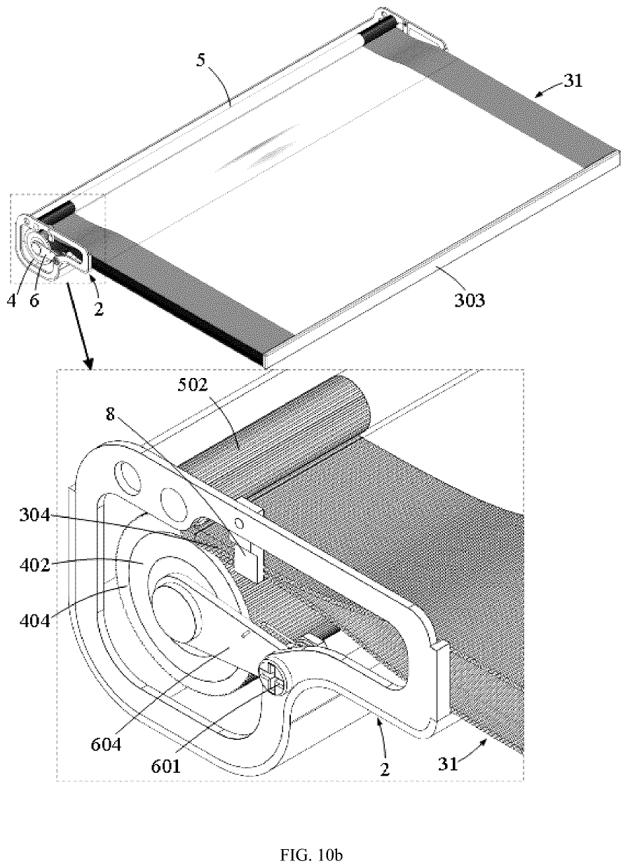

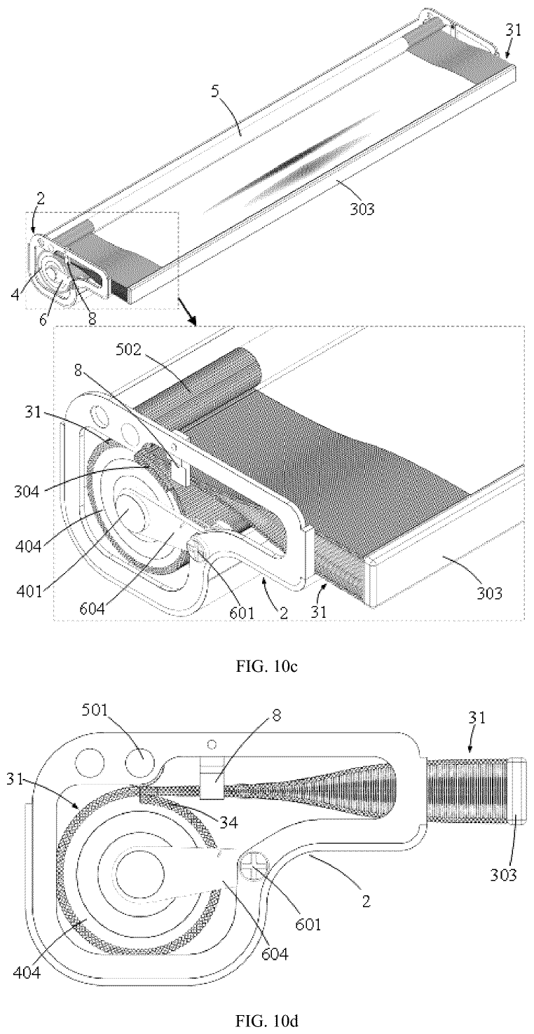

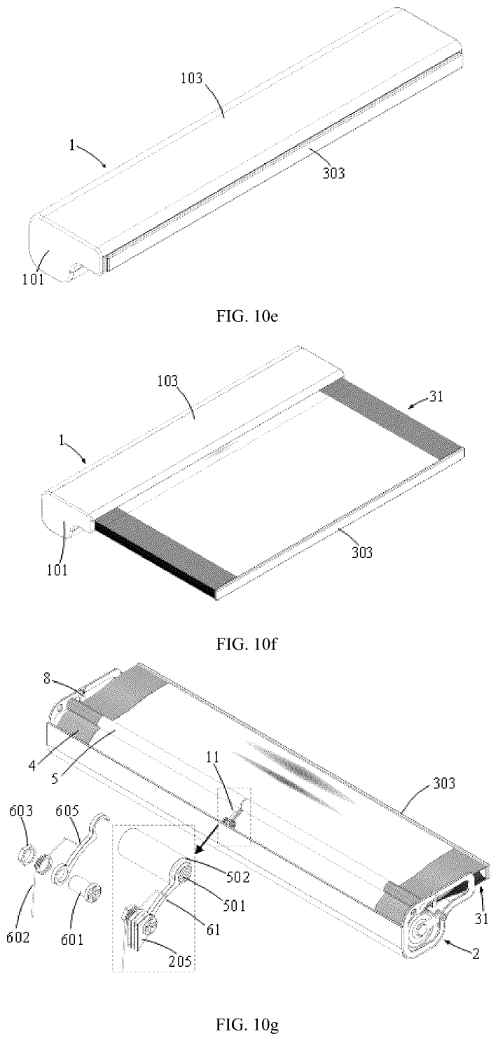

This embodiment provides a unfolding and folding mechanism for a thin-wall structure with a toothed surface, which is particularly suitable for the thin-wall structure with the toothed surface described in Embodiment 9, as shown in FIGS. 9a, 10a-10g. The connection end 310 of the unfolded two-Omega core plate 31 is connected to the roller connection end 403, and the distance between the starting and ending points of the spiral expansion line at the interface is the sum of the thickness of the mounting layer and the thickness of the toothed two-Omega core plate 31.

The smooth section of the toothed two-Omega core plate 31 is used to stick flexible components such as flexible screens, flexible solar panels, and thin film antennas, or the panel of the toothed two-Omega core plate 31 is designed with a full toothed surface to facilitate better bonding with flexible components.

In this embodiment, the roller 404 and the compression wheel 502 are only provided with teeth that mesh with the toothed two-Omega core plate 31 in corresponding areas on both sides of the outer peripheral surface. The middle of the roller 404 and the compression wheel 502 are both smooth surfaces, that is, the surface of the roller 404 is divided into a roller toothed section 4041 and a roller smooth section 4042, and the surface of the compression wheel 502 is divided into a compression wheel toothed section 5021 and a compression wheel smooth section 5022.

As shown in FIG. 10g, in order to increase the clamping stiffness of the long and thin compression wheel 502, an open cantilever elastic support component 61 is also connected between the compression wheel 502 and the frame 2. In this embodiment, the compression wheel 502 is divided into two sections, and the compression wheel shaft between the two compression wheels 502 is provided with an open cantilever elastic support component 61, which is connected to the support lug 205 at the rear of the frame 2.

The open cantilever elastic support component 61 includes a hinge shaft 601, a torsion spring 602, and a locking component 603, which differs from the cantilever elastic support component 60 in that it includes an open cantilever 605. One end of the open cantilever 605 is provided with a through hole, and the hinge shaft 601 passes through the support lug 205 and the through hole to cooperate with the torsion spring 602 and the locking component 603. The locking component 603 is connected between the support lug 205 and the open cantilever 605. The other end of the open cantilever 605 is a hook structure, which hooks the compression wheel shaft 501 through the hook structure.

Similarly, the roller 404 and the compression wheel 502 unfold and fold the toothed two-Omega core plate 31 based on the meshing and squeezing action. The structural stacking layer will not be loosely rolled and delaminated under the action of internal shear teeth and external transmission teeth. Besides, through the cooperation of the smooth surface and toothed surface of the roller 404 and the compression wheel 502, it can be applied to the toothed two-Omega core plate 31 with a larger unfolding zone.

Due to the exhaust and suction behavior of the internal cavity of the structure during the folding, unfolding, and unfolding process of the toothed two-Omega boom 30, exhaust holes are provided at the panel or plug 33 below the toothed two-Omega core plate 31. It is preferred to open exhaust holes at the toothed two-Omega core plate 31 in the inner section of the shell 1.

Other structures are the same as Embodiment 2, and will not be repeated here.

### Embodiment 11

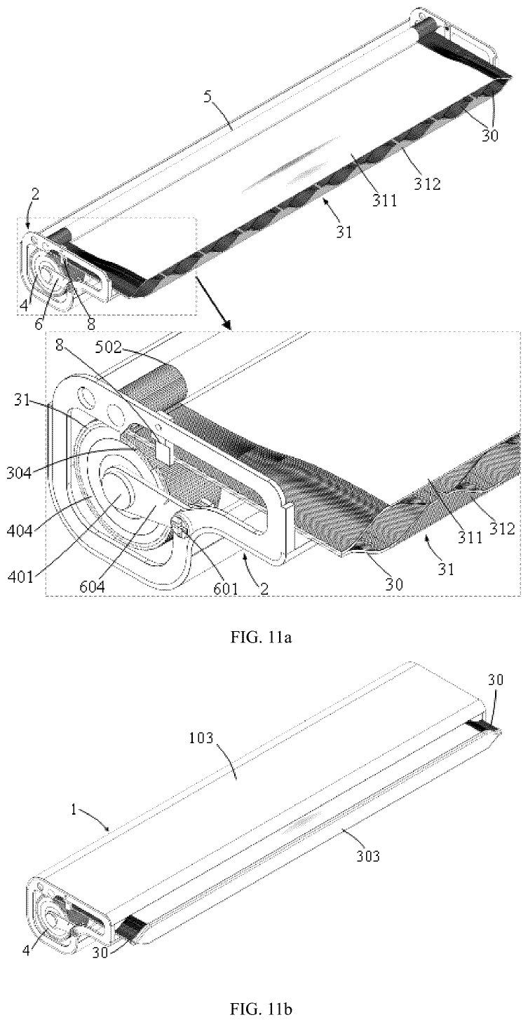

This embodiment provides a thin-wall structure with a toothed surface, which differs from Embodiment 9 in that the cross-sectional shape of the toothed two-Omega core plate 31, as shown in FIGS. 11a and 11b. The elastic sandwiched layer of the toothed two-Omega core plate 31 is a toothed two-Omega boom 30, and the toothed two-Omega boom 30 located at the edge extends from the side of the first elastic thin plate 311 and the second elastic thin plate 312, forming an exposed area. Moreover, the outer surfaces of the first elastic thin plate 311 and the second elastic thin plate 312 are smooth, and the two sides of the first elastic thin plate 311 and the second elastic thin plate 312 are aligned with the central axis of the toothed two-Omega boom 30.

For the unfolding and folding mechanism with the thin-wall structure with the toothed surface, the teeth of the roller 404 and the compression wheel 502 mesh with the teeth of the exposed area of the toothed two-Omega boom 30 for transmission.

Other structures are the same as Embodiment 10, and will not be repeated here.

### Embodiment 12

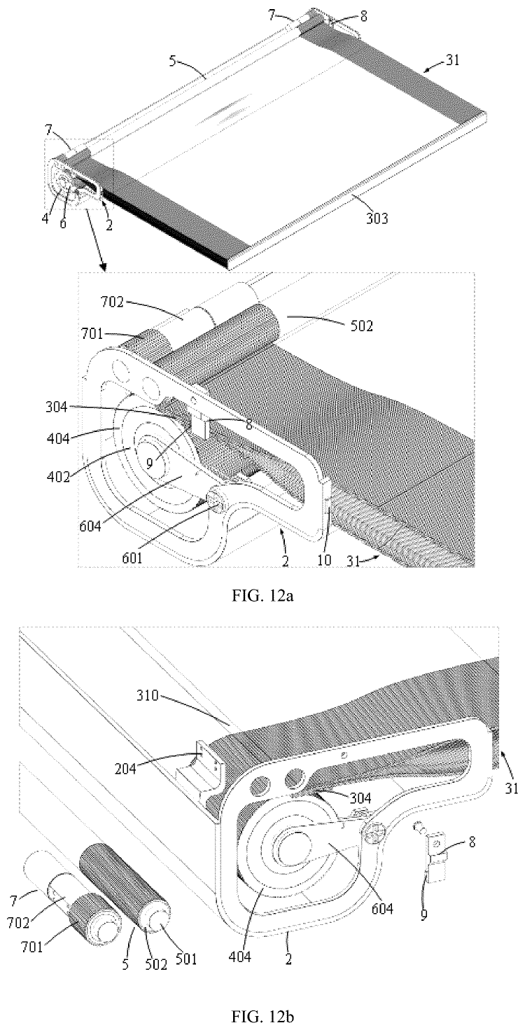

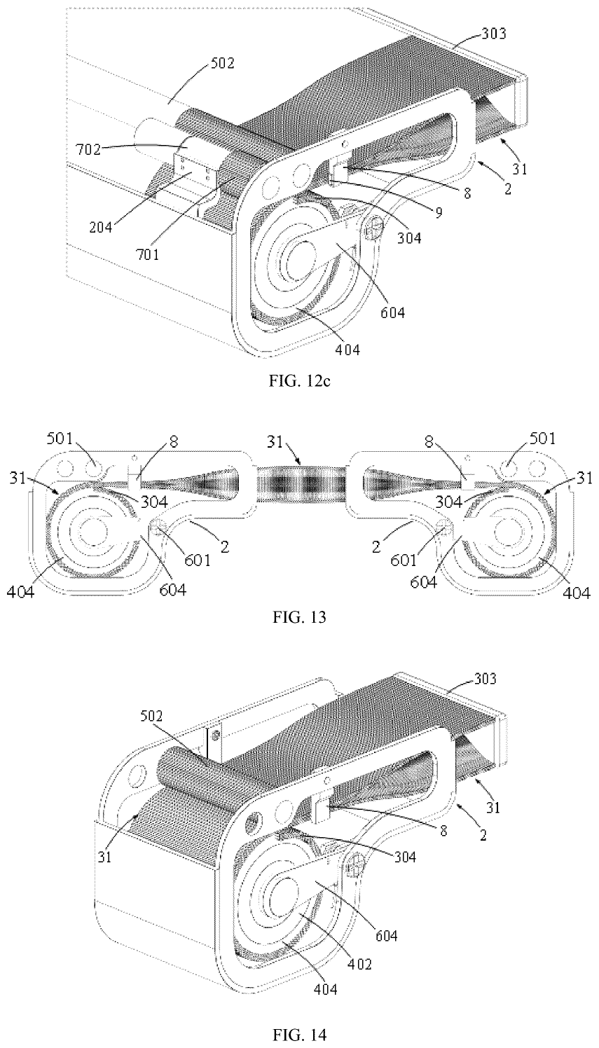

This embodiment provides a unfolding and folding mechanism of a thin-wall structure with a toothed surface, which differs from Embodiment 10 in that a driving mechanism 7 is provided, as shown in FIGS. 12a-12c. The driving mechanism 7 is set up in two groups, corresponding to the compression gear toothed section 5021, and the two driving mechanisms 7 are symmetrically distributed with respect to the perpendicular bisector of the axis of the compression wheel shaft 501.

Other structures are the same as Embodiment 10, and will not be repeated here.

### Embodiment 13

This embodiment provides a unfolding and folding mechanism of a thin-wall structure with a toothed surface, which differs from Embodiment 10 in that Embodiment 10 is a single machine type of single set of a unfolding and folding mechanism, while this embodiment is a dual machine type of dual set of a unfolding and folding mechanism, as shown in FIG. 13. The two ends of the toothed two-Omega core plate 31 are respectively connected to the two sets of oppositely arranged rollers 404 in the unfolding and folding mechanism, that is, the two sets of unfolding and folding mechanisms share one toothed two-Omega core plate 31, and the toothed two-Omega core plate 31 is unfolded between the two mechanisms or wound and stored on the rollers 404 inside both mechanisms.

Other structures are the same as Embodiment 10, and will not be repeated here.

### Embodiment 14

This embodiment provides a unfolding and folding mechanism of a thin-wall structure with a toothed surface, which differs from Embodiment 10 is that, as shown in FIG. 14, the structure of this embodiment is a single-cell toothed boom core structure, that is, only two semi-sectional toothed two-Omega booms 313 with outward openings are clamped between two elastic thin plates, and the toothed two-Omega boom 30 is not clamped in the middle region.

Other structures are the same as Embodiment 10, and will not be repeated here.

In summary, the thin-wall structure with the toothed surface provided by the present disclosure can effectively reduce the “shear lag effect” caused by bending during the unfolding and folding of the boom structure, prevent local thin-wall instability and outward bending deformation (wrinkles or unevenness) of the boom caused by inconsistent longitudinal deformation of the boom, and at the same time, the toothed surface can serve as a reinforcing rib for the elastic sheet to increase the bending stiffness of the structure.

The unfolding and folding mechanism of the thin-wall structure with the toothed surface proposed by the present disclosure can effectively solve the problems of use and adaptation of the device in different fields through various connection methods and unfolding/folding methods, expanding the application scope of the device. It can serve as a supporting framework for flexible devices such as flexible solar cells and thin film antennas, with advantages such as lightweight, high storage ratio, large unfolding zone, easy unfolding, high load-bearing capacity, and resistance to damage.

Certainly, the above descriptions are merely preferred embodiments of the present disclosure. The present disclosure is not limited to the above embodiments listed. It should be noted that, all equivalent replacements and obvious variations made by any person skilled in the art under the teaching of the specification fall within the essential scope of the specification and shall be protected by the present disclosure.

What is claimed is:

1. A thin-wall structure with a toothed surface, wherein the thin-wall structure with the toothed surface is a single-layer thin-wall structure with the toothed surface that can be unfolded and folded, or a multi-layer thin-wall structure with the toothed surface that can be unfolded and folded, the thin-wall structure with the toothed surface has a toothed surface for transmitting interlayer shear forces or meshing transmission.

2. The thin-wall structure with the toothed surface according to claim 1, wherein the single-layer thin-wall structure with the toothed surface is a C-shaped-cross-section boom;
the multi-layer thin-wall structure with the toothed surface is a toothed two-Omega boom, a toothed two-Omega core plate, a double C-shaped-cross-section boom, a herringbone-cross-section boom, and a Z-shaped-cross-section boom.

3. The thin-wall structure with the toothed surface according to claim 2, wherein the toothed two-Omega core plate comprises a first elastic thin plate, a second elastic thin plate, and a hollow elastic sandwiched layer arranged between the first elastic thin plate and the second elastic thin plate;
the first elastic thin plate and the second elastic thin plate can be laminated with the hollow elastic sandwiched layer to form a bendable layered structure under compression force.

4. The thin-wall structure with the toothed surface according to claim 3, wherein the hollow elastic sandwiched layer adopts a semi-sectional toothed two-Omega boom, and at least one side of outer surfaces of the first elastic thin plate and the second elastic thin plate is provided with a toothed section, and its remaining section is a smooth section.

5. The thin-wall structure with the toothed surface according to claim 3, wherein the hollow elastic sandwiched layer comprises multiple sequentially arranged toothed two-Omega booms, and at least one side of the first elastic thin plate and the second elastic thin plate has toothed two-Omega booms exposed to form a toothed section;
the outer surfaces of the first elastic thin plate and the second elastic thin plate are smooth surfaces.

6. A unfolding and folding mechanism of a thin-wall structure with a toothed surface, wherein comprising a roller component, a compression wheel component, and an elastic adjustment mechanism integrated together by a frame, the elastic adjustment mechanism is used to maintain an elastic compression force of the roller component and the compression wheel component;
the roller component comprises a roller shaft and a roller rotatably connected to the roller shaft, and the compression wheel component comprises a compression wheel shaft and a compression wheel rotatably connected to the compression wheel shaft; surfaces of the roller and the compression wheel are respectively provided with transmission teeth for meshing with teeth of the thin-wall structure with the toothed surface.

7. The unfolding and folding mechanism of the thin-wall structure with the toothed surface according to claim 6, wherein the elastic adjustment mechanism is connected between the roller shaft and the frame, or between the compression wheel and the frame, or between the roller shaft and the compression wheel.

8. The unfolding and folding mechanism of the thin-wall structure with the toothed surface according to claim 7, wherein the elastic adjustment mechanism is a cantilever elastic support component, and two ends of the roller shaft or compression wheel shaft are connected to the frame through the cantilever elastic support component;
the cantilever elastic support component comprises a cantilever and an elastic hinge component, one end of the cantilever is connected to the roller shaft or the compression wheel shaft, and the other end is hinged to the frame through the elastic hinge component.

9. The unfolding and folding mechanism of the thin-wall structure with the toothed surface according to claim 7, wherein the elastic adjustment mechanism is a scissor-typed elastic support component, and two ends of the roller shaft are respectively connected to the corresponding ends of the compression wheel shaft through the elastic support component;
the scissor-typed elastic support component includes a pair of scissor blades and the elastic hinge component that hinges one end of the pair of scissor blades, the end of the scissor blade that is far away from the elastic hinge component is respectively connected to the roller shaft and the compression wheel shaft.

10. The unfolding and folding mechanism of the thin-wall structure with the toothed surface according to claim 9, wherein the elastic hinge component comprises a hinge shaft, a locking component, and a torsion spring, the hinge shaft is equipped with the torsion spring, which is connected between the cantilever and the frame; the torsion spring stores elastic potential energy for driving the cantilever to drive the roller and the compression wheel to continuously roll and fold the thin-wall structure with the toothed surface.

11. The unfolding and folding mechanism of the thin-wall structure with the toothed surface according to claim 7, wherein the elastic adjustment mechanism is a C-shaped elastic connection frame, and two ends of the roller shaft are respectively connected to the corresponding ends of the compression wheel shaft through the C-shaped elastic connection frame.

12. The unfolding and folding mechanism of the thin-wall structure with the toothed surface according to claim 6, wherein the compression wheel is a single-segment compression wheel or a multi-segment compression wheel, and one or more open cantilever elastic support components or cantilever elastic support components for increasing rolling stiffness are connected between the compression wheel shaft of the multi-segment compression wheel and the frame;
the open cantilever elastic support component comprises an open cantilever, one end of which is hung with the compression wheel shaft, and the other end is connected to the frame through a hinge shaft, and the hinge shaft is equipped with the torsion spring, which is connected between the open cantilever and the frame.

13. The unfolding and folding mechanism of the thin-wall structure with the toothed surface according to claim 6, wherein at least one side of the connection end between the thin-wall structure with the toothed surface and the roller is provided with a widened portion, and the frame is provided with a blocking block for blocking the widened portion.

14. The unfolding and folding mechanism of the thin-wall structure with the toothed surface according to claim 6, further comprising: a driving mechanism for driving the compression wheel or roller to rotate;
the frame is equipped with at least one stop switch, and the driving mechanism is electrically connected to the stop switch to stop when the thin-wall structure with the toothed surface is unfolded to a limit position.

15. The unfolding and folding mechanism of the thin-wall structure with the toothed surface according to claim 6, wherein the unfolding and folding mechanism is a single machine or dual machine typed;
when the unfolding and folding mechanism is a single machine typed, the thin-wall structure with the toothed surface is unfolded at an outlet end of the unfolding and folding mechanism;
when the unfolding and folding mechanism is a dual machine typed, the thin-wall structure with the toothed surface is unfolded between the two unfolding and folding mechanisms or wound and stored on the roller inside both.
